(19) United States
(12) Patent Application Publication
(10) Pub. No.: US 2020/0148387 A1
(43) Pub. Date: May 14, 2020

(54) Recovery System for UAV

(71) Applicant: Norwegian University of Science and Technology (NTNU), Trondheim (NO)

(72) Inventors: Tor Arne JOHANSEN, Trondheim (NO); Thor Inge FOSSEN, Trondheim (NO); Kristian KLAUSEN, Trondheim (NO)

(21) Appl. No.: 16/604,436

(22) PCT Filed: Apr. 12, 2018
(86) PCT No.: PCT/EP2018/059446

§ 371 Date: Oct. 10, 2019

(30) Foreign Application Priority Data
Apr. 12, 2017 (GB) 1705903.1
Apr. 12, 2017 (GB) 1705904.9

(51) Int. Cl. B64F 1/02; B64C 39/02

(52) U.S. Cl. CPC B64F 1/02; B64C 39/024; B64C 2201/021; B64C 2201/143; B64C 2201/182; B64C 2201/206; B64C 2201/027

(57) ABSTRACT

An unmanned airborne vehicle (UAV) recovery system for in-flight recovery of a fixed wing UAV includes a catching device and a plurality of hover-capable drones, such as multi-rotors. The catching device is for catching the fixed wing UAV via a hook system during flight of the fixed wing UAV and takes the form of a line between the recovery drones. The recovery drones are arranged to support the catching device as it spans a gap in a horizontal orientation with the catching device suspended between at least two recovery drones that are in flight and spaced apart horizontally from each other either side of the gap. During a recovery operation the recovery drones co-ordinate their movement to adopt a flight path relative to a flight path of the fixed wing UAV to define a virtual runway for interception of the fixed wing UAV by the recovery system.

The invention relates to a method and a system for recovery of a fixed wing aircraft, in particular for the recovery of a fixed wing unmanned aerial vehicle (UAV).

Fixed wing aircraft generate lift through forward movement and as a consequence certain constraints are placed on take-off and landing. A traditional method for take-off and landing of fixed wing aircraft is to use a runway with sufficient length that the aircraft can use its engine to accelerate to a take-off speed and can decelerate safely from a landing speed to a standstill or to a taxiing speed. In some cases there is limited space for take-off and landing and various specialised aircraft have been developed that allow for a shorter take-off and landing distance. It is also known to use catapults and similar systems to aid aircraft in taking off when there sufficient runway length is not available, as well as to use arresting systems to aid deceleration of aircraft when they must land and come to a standstill with a short distance. A well-known example of the use of catapults and arresting systems is in relation to aircraft carriers. Land based assisted take-off is also known, for example in relation UAVs to light aircraft and gliders, i.e. fixed wing aircraft that do not rely on an engine during free flight. It is possible for aircraft to be launched without any runway at all, for example with catapult system as used on-board ships.

Assisted take-off systems are also used connection with fixed wing UAVs. A number of systems are available that allow for UAVs to be launched without the need for any kind of runway and thus enable UAVs to be launched from any location, such as from on board a ship or from a land based site without any suitable infrastructure for providing a runway. It will be understood that the considerations that apply with fixed wing UAVs are somewhat different than for rotorcraft UAVs, which can hover and therefore are capable of vertical take-off and landing.

In some cases a fixed wing UAV might be launched without any kind of runway and then landed in a different location where a runway, landing field, or suitable infrastructure (such as a road) is present. In a maritime context the aircraft may be able to land on the sea and be recovered to their parent vessel from the water. UAVs may be designed to be recovered by a rough landing on generally flat terrain, i.e. effectively a crash-landing, or by use of a parachute system. Both of those options give rise to operational constraints as well as a risk of damage to the UAV.

In order to take full advantage of the ability for fixed wing UAVs to take off without the use of a runway it is desirable to also be able to recover a fixed wing UAV in a way that also dispenses with the need for a runway type landing, whether it be on a traditional runway, on some kind of ad hoc runway such as an open field forming a landing field, or as a ‘crash landing’ on generally flat terrain. An effective system for recovery of a fixed wing UAV should do so without risk of damage to the UAV and ideally in a way that allows for re-use of the recovery system.

In the prior art various proposals have been made relating to recovery of fixed wing UAVs. For example, WO01/07318, which proposes launching the UAV using a parasail, discloses various systems for recovery including for the UAV to fly into and latch onto the parasail tow line or onto a vertical line hanging from the parasail or from another, such as the helicopter. There is also consideration of the use of a net attached to the parasail or a net attached to poles on land.

Capture of a UAV by the aircraft latching onto a swing arm system has also been proposed, for example in EP 2186728 and WO 2013/171735. The latter document also includes various alternative possibilities such as a line strung between two poles on a vehicle or on land and various combinations of arresters for preventing a hard landing of the UAV.

In U.S. Pat. No. 9,359,075 a fixed wing UAV is recovered using a vertical line that can be suspended from a hovering aircraft such as a helicopter or a multi-rotor UAV. The fixed wing UAV is modified by the addition of a hooking system at a wingtip and the motion of the fixed wing UAV is arrested when it hooks onto the vertical line, with deceleration occurring due to reaction of the aircraft motion against the hovering aircraft and against an anchor assembly fixed to the ground or to a ship.

Viewed from a first aspect, the invention provides an unmanned airborne vehicle (UAV) recovery system for in-flight recovery of a fixed wing UAV, the recovery system comprising: a catching device comprising a line for catching the fixed wing UAV during flight of the fixed wing UAV via a hook system; and a plurality of hover-capable recovery drones; wherein the recovery drones are arranged to support the line as it spans a gap in a horizontal orientation with the line suspended between at least two recovery drones that are in flight and spaced apart horizontally from each other either side of the gap; and wherein the recovery drones are arranged to co-ordinate their movement to adopt a flight path relative to a flight path of the fixed wing UAV to define a virtual runway for interception of the fixed wing UAV by the recovery system.

The recovery system may further include a hook arrangement for the fixed wing UAV, such as a hook with a hook line attached, wherein the hook line has a length allowing for the fixed wing UAV to fly above the recovery drones whilst the hook hangs below the level of the line supported between the drones, such that the hook can hook onto the catching device line to thereby capture a fixed wing UAV to which the hook line is attached. The line of the catching device may be a flexible line arranged to hang suspended between the at least two recovery drones, for example it may hang in a catenary arc suspended from the recovery drones. The line may be held in tension between the recovery drones so that it is taut when interception the fixed wing UAV via the hook system. With the use of a line between the recovery drones as a catching device, and a hook line hanging from the fixed wing UAV with a hook for attaching to the catching device line, then the accuracy required in the co-ordination of the flight paths for the virtual runway and the fixed wing UAV is relatively low since there can be a variation in both height and in alignment as allowed for by the horizontal length of the catching device line and the vertical length of the hooking line. In example embodiments, as discussed below, the hook can be deployable from the fixed wing UAV with the hook line having a variable length beneath the fixed wing UAV, such as by use of a reel or spool arrangement. This adds further flexibility and gives advantages compared to a hook arrangement where the hook is immobile on the fixed wing UAV, leading to reduced flexibility and an increased need for accuracy during the recovery operation.

With the proposed recovery system a virtual runway can be located along any flight path where free flight of the recovery drones is possible. Each of the recovery drones may fly in co-ordination both with the other recovery drone(s) and with the flight path of the fixed wing UAV to be recovered. Thus, the recovery system involves a unique control objective for the recovery drones which is set to determine a flight path for the drones to provide the virtual runway based on a flight path of the fixed wing UAV. The fixed wing UAV flight path can be set based on weather conditions and other considerations and the UAV does not need to adapt its flight path to suit a specified recovery location or flight direction. The recovery drones have a flight path that may react dynamically to the UAV flight path. The flight path may include movement of the recovery drones in the same direction as the fixed wing UAV so that the relative velocity of the recovery system and the fixed wing UAV is reduced. The virtual runway may advantageously be aligned with weather conditions so that the fixed wing UAV is flying into the wind when it lands. When the fixed wing UAV flight path is into the wind and the recovery drones are also flying into the wind then this ensures greatest stability during the catching of the fixed wing UAV as well as minimal ground speed for the fixed wing UAV and for the virtual runway.

Hence, significant advantages are provided compared to prior art arrangements where there are constraints on the location for the recovery and/or on the direction of the fixed wing UAV flight path. Such constraints may be with reference to the location and orientation of a ship as with the parasail line of the prior art referenced above, or due to the location and orientation of a ground installation such as the supporting poles, ground anchors or swing arms of the prior art systems. In fact, with the proposed recovery system the fixed wing UAV can be controlled in a way that is blind to the presence of the recovery system, since the recovery system can match its movements with the fixed wing UAV flight path without the need for co-ordination or co-operation from the fixed wing UAV.

There are additional advantages when using a line for a catching device and a hook system attached to the UAV in relation to the structural loads on the UAV. The hook system can be attached closer to the centre of gravity than for some prior art devices, and can be attached at a strong point on the UAV. This is in contrast to prior art systems where a wingtip hook is used, in which case the impact of the UAV with the catching device will generate higher stresses on the UAV airframe.

The recovery drones are hover-capable drones and may be any type of drones that are capable of vertical take-off and landing as well as flight along a defined flight path. The recovery drones may all be the same type of drone, which can have advantages in terms of co-ordinated movement, although it will be appreciated that in some cases multiple different types of drones may be used. The recovery drones might typically be rotorcraft drones such as multi-rotor drones. Multi-rotor drones such as quadcopters are expected to be capable of absorbing and damping the loads that will arise from impact of the fixed wing UAV on the catching device. The recovery drone will include a control system for controlling some or all aspects of the flight of the recovery drone, which may be based on external remote control inputs and/or on control algorithms at the recovery drone allowing for autonomous operation. Where the recovery drone is described herein as being arranged to act in a certain way then this may involve the control system being adapted to cause the recovery drone to act in that way.

The recovery system uses at least two recovery drones, with one drone at either side of the horizontal gap spanned by the catching device. More than one drone may be used at either side of the horizontal gap. For example, groups of two or more drones at each side of the horizontal gap may add extra lifting capability and or the ability to absorb larger impact loads than using a single drone at each side. Using multiple smaller drones instead of fewer numbers of larger drones may also provide additional flexibility in a recovery system used during various weather conditions and/or for different types of fixed wing UAVs, so that the operator can use the smallest number of recovery drones required to give a required lifting capability.

The speed of the fixed wing UAV can be a typical flight speed for the fixed wing UAV. For example the fixed wing UAV may have an airspeed of between 10-40 m/s, such as an airspeed of 15-30 m/s. The recovery drones provide a virtual runway that advantageously travels in the same direction as the fixed wing UAV at a lower speed than the fixed wing UAV. The speed of the recovery drones forming the virtual runway may be less than the speed of the fixed wing UAV by 5-10 m/s, and/or it may be an airspeed in the range of 5-20 m/s. The difference in speed is the closing speed of the fixed wing UAV on the virtual runway, which may be in the range 5-20 m/s. Thus, in an example of an airspeed of the fixed wing UAV of about 20 m/s the airspeed of the recovery drones may be in the range 5-20 m/s and could be about 10 m/s, i.e. a closing speed of about 10 m/s. It will be appreciated that this provides a significant reduction in the closing speed compared to the situation where the recovery system is in a fixed location, such as the systems based on land in the prior art referenced above.

The weight of the UAV will determine the lifting capabilities required for the recovery drones and this in turn has an impact on the weight of the recovery drones. For smaller fixed wing UAVs the weight is in the range 2-20 kg, and this might require recovery UAVs with a combined weight of around four times that of the fixed wing UAV, for example two multi-rotors of weight 4-10 kg each. It will be appreciated that a suitable specification for the recovery drone can be set based on the specification of the fixed wing UAV, including its weight as well as the flight speed during the recovery operation. Larger fixed wing UAVs can weigh 50-100 kg and in that case the recovery drones would need to have appropriately increased lifting capabilities, which would also increase their weight.

Impact of the fixed wing UAV on the catching device will lead to potentially large forces on the recovery drones, bearing in mind that there is no ground anchor or the like to react forces to a fixed point. The forces on the recovery drones would typically appear as tensile forces at the point of attachment of the catching device, with the direction of the force being along a line from the point of attachment at the recovery drone to the point where the UAV is hooked to the catching device. The recovery system may include one or more mechanism for absorbing the impact forces. This may be via shock absorbing features of the catching device and/or via control of the recovery drones to damp and/or absorb forces from the impact.

If the recovery system includes shock absorbing features at the catching device then such features may comprise the use of a shock absorbing line, such as a line that extends under load and absorbs or dissipates forces during extension. The shock absorbing features may alternatively or additionally include shock absorbers attached to the catching device within the load path and using damping or plastic deformation to absorb or dissipate forces.

When the recovery system uses control of the recovery drones to damp and/or absorb impact forces, then the recovery drones may be arranged to react to impact of the fixed wing UAV at the catching device by applying lift to counteract the impact forces. This may be done by control of each recovery drone such that in reaction to motion and/or forces arising due to impact of the fixed wing UAV then the recovery drone applies additional lift to maintain, restore or modify the flight path of the recovery drone. In one example the recovery drone may detect motion or forces induced by impact of the fixed wing UAV via sensors on the recovery drone, and input from the sensors as well as control inputs from feedback systems on the recovery drone, such as gyroscopic systems, may be used to maintain stable flight of the recovery drone as well as to maintain, restore or modify the flight path. The recovery drone flight path may be modified by permitting the recovery drone to move into the horizontal gap that was spanned by the catching device prior to impact of the fixed wing UAV. The recovery drone flight path may be modified by acceleration or deceleration of the flight speed along the flight path of the virtual runway. It will be appreciated that the control algorithms of the recovery drone may be adapted to increase or reduce the ‘stiffness’ of the recovery drone's flight in reaction to outside forces that would perturb the flight path of the drone. Suitable adjustments to this stiffness may be made to ensure that the recovery drone has the capability to absorb the impact forces that are applied to the recovery drone, which may be the entire impact forces or may be forces attenuated by shock absorbing features of the catching device.

The recovery drone may include sensors for use during flight to detect impact of the fixed wing UAV via detection of induced motion or forces. The recovery drone may include a system for measuring motion parameters of the recovery drone and this may include one or more accelerometers, angular rate sensors (such as gyros), magnetometers, and/or satellite navigation systems providing position and possibly velocity. For example, the recovery drone may include one or more accelerometers for detecting acceleration of the recovery drone. Such an accelerometer may be used to detect the jerk and/or acceleration applied to the drone when the fixed wing UAV applies an impact force on the catching device. The recovery drone may then react to impact of the fixed wing UAV at the catching device by applying lift to counteract the impact forces taking account of the direction and/or magnitude of jerk and/or acceleration sensed by the accelerometer. Alternatively, or additionally, the recovery system may include one or more sensors for sensing the magnitude and/or direction of tension forces applied to the drone by the catching device. When the fixed wing UAV applies an impact force to the catching device then the magnitude and direction of the tension applied to the recovery drone by the catching device will change. Detecting the change in magnitude and/or direction can hence allow for detection of the impact forces, and the recovery drone may be arranged to react to impact of the fixed wing UAV at the catching device by applying lift to counteract the impact forces taking account of the direction and/or magnitude of the tension applied to the recovery drone by the catching device.

In order to avoid damage to the recover drones or fouling of the lines then the recovery drones may include a guard arrangement to protect moving parts such as rotors from the hook line in case of accidental impact of the line with the recovery drone. For example, the recovery drones may include suitable rotor guard rails.

The recovery drones may be arranged to carry the fixed wing UAV as a suspended load once the fixed wing UAV has been caught by the catching device and after the impact forces have been absorbed. Thus, after any required reaction to absorb the impact forces has been completed then the recovery drones may be arranged to co-ordinate their flight to carry the fixed wing UAV and the catching device together. This may involve a similar co-ordinated flight as the virtual runway, but the recovery drones will be carrying an increased load and may advantageously fly closer together. Closer spacing is possible since there is no need for a wide spacing to set a wide horizontal gap in relation to the accuracy of the co-ordination of the flight path of the virtual runway with the flight path of the fixed wing UAV. Closer spacing will also allow the UAV suspended via the catching device to hang closer to vertical beneath the recovery drones, which means that the majority of the weight of the fixed wing UAV can be held via vertical lift forces from the recovery drones. When the recovery drones are holding the UAV suspended beneath them then their flight patterns and/or control of their flight may be changes compared to flight with the catching device alone in order to take account of the dynamics of the slung load. For example, the load may swing requiring reaction from the recovery drones and/or changes in direction of the recovery drones may involve different forces on the drones due to the slung load.

The control of the recovery drones may use conventional systems for locating and tracking the location of the drones, such as GPS and dead reckoning. The recovery drones may have a generally conventional construction and control system aside from adaptations to the control of the flight of the recovery drones with respect to the added vertical and horizontal load from the catching device and from the UAV after it is caught. The control systems may further be augmented by routines for controlling one or more of the formation and relative position of the recovery drones, alignment with the virtual runway, absorption of UAV impact energy, and/or emergency manoeuvres.

The recovery system may allow for the recovery drones to track the position and velocity of the fixed wing UAV via any suitable tracking system, including non-co-operative tracking such as radar, or a co-operative system. Possible cooperative systems may include a transponder (e.g. ADS-B or Mode S or Mode C) on the fixed wing UAV that broadcasts information on a standard radio protocol; information from the fixed wing UAV's own autopilot's navigation received through its standard command and control radio link, either directly or through its ground control station; a dedicated satellite navigation receiver (e.g. GPS) installed as part of the hook system on the fixed wing UAV, received through a dedicated radio link that is part of the recovery system; or combinations of such systems. A radio datalink between the recovery system and the fixed wing UAV may also be used, for example in order to control the hook system and/or to command a stop of the engine of the fixed wing UAV.

The connection of the catching device to the recovery drone may be a simple mechanical linkage between a connector of the catching device and an attachment point such that there is no modification to the recovery drone aside from addition of a suitable attachment point if one is not present. The attachment point may simply be a ring or eye securely attached to the structure of the recovery drone. The connector of the catching device may include an emergency release for decoupling of the catching device from the recovery drone. Such a decoupling may be arranged to occur automatically in reaction to an overload on the connector and in this case the emergency release may be a passive mechanical device, such as a breakable linkage. The decoupling may also occur with triggering from an external controller, such as triggering by the control system of the recovery drone or from a remote control system. This can allow for a manual release in response to external events (such as incoming adverse weather) or an automated release in response to overloading or a fault detected at the recovery drone.

As noted above the catching device of preferred embodiments comprises a line suspended between the at least two recovery drones. A line has advantages as a catching device compared to alternatives that might be suspended in the same way, such as a net. A line is easier to handle than a net and can be lighter in weight as well as being able to be packed into a smaller space. Since a line is lighter than a net then it can be used with longer horizontal span than a net whilst not increasing the load on the recovery drones, and this means that there is a reduced need for accuracy in co-ordination of the flight path of the virtual runway with that of the fixed wing UAV. The use of a hook suspending on a hook line from the UAV also gives advantages compared to the use of hooks on the UAV for engaging with a net, since again there is a reduction in the accuracy required for interception of the fixed wing UAV by the recovery system. A line also has an advantage in relation to wind loads.

The catching device may be slung across a gap of 5 m or above, such as a gap of 10 m wide or above. As noted above, with a line a wider gap is easier to implement compared to with a net. The line may have a length of 5-100 m, or 10-50 m, and may be suspended across a gap of 10-40 m, optionally hanging in a catenary arc as noted above. In that case the tension from the weight of the line may apply a force to an attachment point at the recovery drone at an angle of between 0 to 45 degrees to the horizontal. The connection at the attachment point may include a sensor for monitoring the direction and/or magnitude of the tension force in the line as discussed above.

The recovery system may also include a hook system for attachment to the fixed wing UAV and this may include a hook and a hook line holding the hook. The fixed wing UAV may conveniently be of generally standard or conventional construction aside from the addition of the hook system, which may be arranged to be attached to the underside of the UAV. The hook system may be provided with a housing for holding the hook line in a stowed arrangement during normal flight, such as being wound on a reel. The housing may also enclose and/or hold the hook before it is deployed. The hook system may be arranged to deploy the hook when the fixed wing UAV is within a certain distance of the recovery drones and/or is within a certain flight time from interception with the catching device at the virtual runway. This distance and/or time may be determined based on the time required to deploy the hook and line with the hook system. The hook and line may be deployed via gravity with the weight of the hook pulling the hook line from its stowed arrangement to a deployed arrangement where the hook and the hook line hang beneath the fixed wing UAV. Alternatively, or additionally, the hook and/or the hook line may be provided with aerodynamic features for using the airspeed of the UAV to generate a downward force to aid deployment of the hook. The hook line may have a length that is sufficient to allow the UAV to fly well above the recovery drones whilst still placing the hook well below the catching device. For example the hook line may allow the UAV to fly at least 5 m above the drones with the hook at least 5 m below the catching device. Depending on the configuration of the catching device, for example depending on how low the arc of a catching line extends beneath the recovery drones, the length of the hook line might be in the range 5-50 m or longer. In one example the length of the hook line is about 20 m with a catching line of about 30 m and a horizontal spacing between drones of about 20 m.

As noted above, the fixed wing UAV need not be affected compared to normal flight in terms of its flight path for interception with the virtual runway. However, it is desirable for the propulsion system of the UAV to shut down once it has been caught by the catching device, or shortly before. This may be achieved using one or more of various systems. The fixed wing UAV may be arranged to automatically shut down its propulsion system in response to impact forces from the catching device. The recovery system and/or the hook system may be arranged to provide a signal to the fixed wing UAV to trigger a shutdown of the propulsion system when the hook engages with the catching device or when the UAV and/or the hook are within a certain distance of the catching device. A remote control system may also be able to trigger a shutdown of the UAV propulsion system. Combinations of these possibilities may be used to provide redundancy.

Viewed from a second aspect, the invention provides a method for recovery of a fixed wing unmanned airborne vehicle (UAV) during flight, the method comprising: using a plurality of hover-capable recovery drones, supporting a catching device as it spans a gap in a horizontal orientation with the catching device suspended between at least two recovery drones that are in flight and spaced apart horizontally from each other either side of the gap, wherein the catching device is a line for catching the fixed wing UAV during flight of the fixed wing UAV using a hook system attached to the UAV; co-ordinating movement of the recovery drones in order to that they adopt a flight path relative to a flight path of the fixed wing UAV; and thereby defining a virtual runway for interception of the fixed wing UAV by the recovery system.

The method of this aspect may make use of a recovery system having any of the features discussed above in connection with the first aspect. The recovery system may further include a hook arrangement for the fixed wing UAV, such as a hook with a hook line attached, wherein the hook line has a length allowing for the fixed wing UAV to fly above the recovery drones whilst the hook hangs below the level of the line supported between the drones. In this case then the method may include catching the fixed wing UAV by hooking the hook onto the catching device line so that the fixed wing UAV is then attached to the catching device, and hence to the recovery drones, by the hook line. The line of the catching device may be a flexible line that hangs suspended between the at least two recovery drones whilst they define the virtual runway, for example it may hang in a catenary arc suspended from the recovery drones.

The method allows for the virtual runway to be located along any flight path where free flight of the recovery drones is possible. Each of the recovery drones may fly in co-ordination both with the other recovery drone(s) and with the flight path of the fixed wing UAV to be recovered. The movement of the recovery drones may be in the same direction as the fixed wing UAV so that the relative velocity of the recovery system and the fixed wing UAV is reduced. The virtual runway may advantageously be aligned with weather conditions so that the fixed wing UAV is flying into the wind when it lands. When the fixed wing UAV flight path is into the wind and the recovery drones are also flying into the wind then this ensures greatest stability during the catching of the fixed wing UAV as well as minimal ground speed for the fixed wing UAV and for the virtual runway. The method can include controlling the fixed wing UAV in a way that is blind to the presence of the recovery system, since the recovery system can match its movements with the fixed wing UAV flight path without the need for co-ordination or co-operation from the fixed wing UAV.

The recovery drones are hover-capable drones and the method may include using any type of suitable drones as discussed above. The recovery drone will include a control system for controlling some or all aspects of the flight of the recovery drone, which may be based on external remote control inputs and/or on control algorithms at the recovery drone allowing for autonomous operation. Where the method includes steps in which the recovery drone acts in a certain way then this may involve adapting or using the control system to cause the recovery drone to act in that way.

The speed of the fixed wing UAV and/or the recovery drones may be as discussed above. The method may include defining a virtual runway that travels in the same direction as the fixed wing UAV at a lower speed than the fixed wing UAV, with a closing speed as discussed above.

The method may include absorbing impact forces from the catching of the fixed wing UAV, for example by using one or more mechanism for absorbing the impact forces. This may be done via shock absorbing features of the catching device, for example as discussed above, and/or via control of the recovery drones to damp and/or absorb forces from the impact. When the recovery system uses control of the recovery drones to damp and/or absorb forces from the impact, then the method may include controlling the recovery drones to react to impact of the fixed wing UAV at the catching device by applying lift to counteract the impact forces, for example by controlling each recovery drone such that in reaction to motion and/or forces arising due to impact of the fixed wing UAV then the recovery drone applies additional lift to maintain, restore or modify the flight path of the recovery drone. The method may include detecting motion or forces induced by impact of the fixed wing UAV by using sensors on the recovery drone, and then using input from the sensors as well as control inputs from feedback systems on the recovery drone, such as gyroscopic systems, in order to maintain stable flight of the recovery drone as well as to maintain, restore or modify the flight path. The recovery drone flight path may be modified by permitting the recovery drone to move into the horizontal gap that was spanned by the catching device prior to impact of the fixed wing UAV. The recovery drone flight path may be modified by accelerating or decelerating the co-ordinated movement of the recovery drones along the flight path of the virtual runway.

The sensors at recovery drone may include one or more accelerometers for detecting acceleration of the recovery drone and the method may include using the accelerometer to detect a jerk and/or acceleration applied to the drone when the fixed wing UAV applies an impact force on the catching device, and then controlling the recovery drone to react to impact of the fixed wing UAV at the catching device by applying lift to counteract the impact forces taking account of the direction and/or magnitude of jerk and/or acceleration sensed by the accelerometer. Alternatively, or additionally, the recovery system may include one or more sensors for sensing the magnitude and/or direction of tension forces applied to the drone by the catching device and the method may include detecting a change in magnitude and/or direction in order to detect the impact forces, and then controlling the recovery drone to react to impact of the fixed wing UAV at the catching device by applying lift to counteract the impact forces taking account of the direction and/or magnitude of the tension applied to the recovery drone by the catching device.

The method may include catching the fixed wing UAV, absorbing the impact forces, and then carrying the fixed wing UAV as a suspended load. Thus, after absorbing the impact forces the recovery drones may co-ordinate their flight to carry the fixed wing UAV and the catching device together, for example as discussed above.

The catching device of preferred embodiments comprises a line suspended between the at least two recovery drones, which has advantages as discussed above. The method may include using a hook system attached to the fixed wing UAV, with the hook system including a hook and a hook line holding the hook. The hook system may be provided with a housing for holding the hook line in a stowed arrangement during normal flight, such as being wound on a reel. The housing may also enclose and/or hold the hook before it is deployed. The method may include using the hook system to deploy the hook when the fixed wing UAV is within a certain distance of the recovery drones and/or is within a certain flight time from interception with the catching device at the virtual runway. The method may include determining this distance and/or time based on the time required to deploy the hook and line with the hook system, which may be done prior to starting the recovery operation or it may be done in-flight taking account of potentially varying factors such as flight speeds and weather conditions. The method can include shutting down the propulsion system of the fixed wine UAV as discussed above.

In a third aspect, as an adaptation to the UAV recovery system of the first aspect, the invention provides an unmanned airborne vehicle (UAV) recovery system for in-flight recovery of a fixed wing UAV, the recovery system comprising: a catching device for catching the fixed wing UAV during flight of the fixed wing UAV; and a plurality of hover-capable recovery drones; wherein the recovery drones are arranged to support the catching device as it spans a gap in a horizontal orientation with the catching device suspended between at least two recovery drones that are in flight and spaced apart horizontally from each other either side of the gap; and wherein the recovery drones are arranged to co-ordinate their movement to adopt a flight path relative to a flight path of the fixed wing UAV to define a virtual runway for interception of the fixed wing UAV by the recovery system.

Thus, the line of the first aspect may be replaced by a catching device with any other form as well in this adapted aspect. The catching device of the third aspect may for example be a line supported across a horizontal span by drones at either end of the line (e.g. as described above), or it may be a net that is hung from the recovery drones and/or suspended between the recovery drones. Where a net is used then the fixed wing UAV may be caught by setting the virtual runway so that the flight path of the fixed wing UAV passes through the net, and by using hooks or similar on the UAV that will engage with the net or by arranging the net so that upon impact of the UAV it will envelop the UAV and hold it without the need for hooks. In the case of a line as the catching device then a hook system may be used to engage the UAV with the catching device. In the case of either a line or a net the interception of the fixed wing UAV may involve defining the virtual runway so that the flight path of the fixed wing UAV is over the line or net, and so that the UAV may be caught by the line or the net using a hook suspended beneath the UAV. The system of the third aspect may include any of the optional features discussed above in relation to the first aspect.

Similarly, viewed from a fourth aspect, an adapted method for recovery of a fixed wing UAV during flight comprises: using a plurality of hover-capable recovery drones, supporting a catching device as it spans a gap in a horizontal orientation with the catching device suspended between at least two recovery drones that are in flight and spaced apart horizontally from each other either side of the gap, wherein the catching device is for catching the fixed wing UAV during flight of the fixed wing UAV; co-ordinating movement of the recovery drones in order to that they adopt a flight path relative to a flight path of the fixed wing UAV; and thereby defining a virtual runway for interception of the fixed wing UAV by the recovery system.

Thus, as with the third aspect the line of the second aspect may be replaced by a catching device with any other form. The method of this aspect may make use of a recovery system having any of the features discussed above in connection with the first aspect or the third aspect. The catching device may for example be a line supported across a horizontal span by drones at either end of the line, or it may be a net that is hung from the recovery drones and/or suspended between the recovery drones. Where a net is used then the method may include catching the fixed wing UAV by setting the virtual runway so that the flight path of the fixed wing UAV passes through the net, and by using hooks or similar on the UAV that will engage with the net. In the case of either a line or a net intercepting the fixed wing UAV may include defining the virtual runway so that the flight path of the fixed wing UAV is over the line or net, and so that the UAV may be caught by the line or the net using a hook suspended beneath the UAV. The method of the fourth aspect may include any of the features described above in relation to the method of the second aspect.

Viewed from a further aspect, the invention provides a computer programme product comprising instructions that, when executed on a control network for controlling hover-capable recovery drones, will configure them to support a catching device and co-ordinate their flight to define a virtual runway in accordance with the method of the second aspect or the method of the fourth aspect. The instructions may be arranged to configure the recovery drones to perform any other feature of the method discussed above in relation to control of the recovery drones.

Certain preferred embodiments of the current invention will now be described by way of example only and with reference to the accompanying drawings in which:

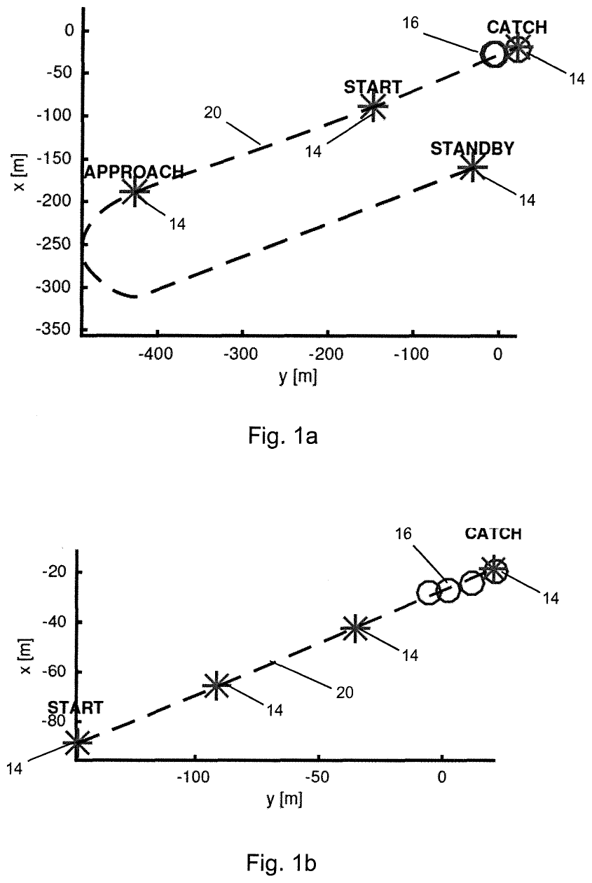

FIGS. 1a and 1b show flight paths for recovery drones defining a virtual runway for recovery of a fixed wing UAV;

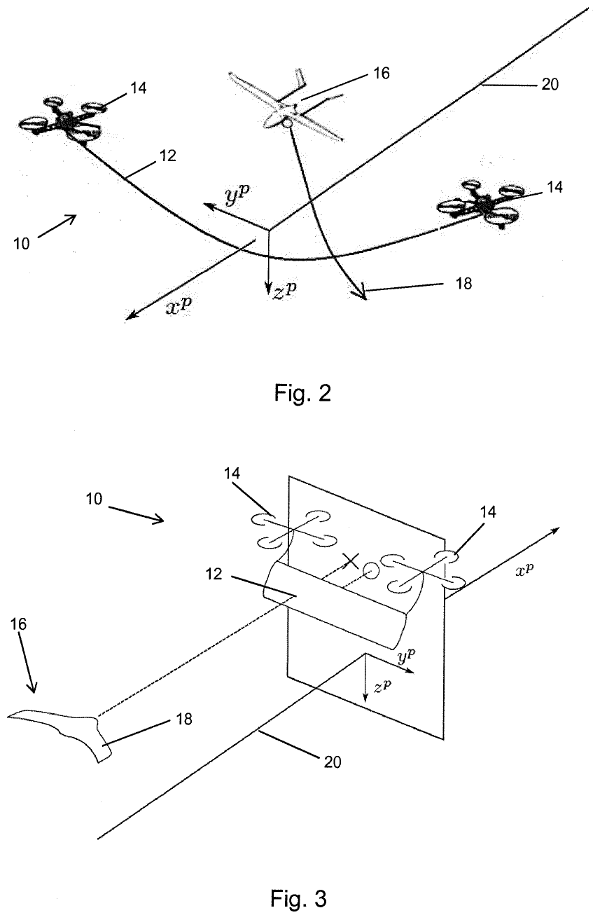

FIG. 2 illustrates multi-rotors holding a catching device in the form of a line for catching a fixed wing UAV; and

FIG. 3 illustrates multi-rotors holding a catching device in the form of a net.

As discussed above, it is beneficial to be able to recover a fixed wing UAV during flight without the need for the recovery system to be linked to any particular location such as a ship or a ground anchor. In UAV recovery systems 10 proposed herein, as shown in the Figures, a horizontally arranged catching device 12 is suspended between two multi-rotor drones 14 and this is used to intercept a fixed wing UAV 16 during flight. The catching device takes the form of a line 12. In order to use the catching device 12 to intercept the fixed wing UAV 16 the recovery drones 14 are flown in a co-ordinated manner to define a virtual runway 20.

Key benefits of the proposed approach include:
Operational flexibility: When recovering a fixed wing UAV 16, it is crucial to travel against the wind to minimize the ground speed, and thus the catching device 12 needs to be aligned with this path. Even in marine vessels equipped with Dynamic Positioning (DP) systems, turning the ship can be undesired as it may interfere with operations. The multirotors 14 can however quickly react to changing wind conditions, and align the catching device 12 against the wind without interfering with other ship operations.
Not affected by waves and turbulence in marine operations: Since the catching device 12 is suspended free from the ship, heave motion induced by waves on the ship will not affect the landing. Also, there is no impact from turbulence caused by the ship super-structure.
Not affected by ground conditions during inland or littoral operations: Since the catching device 12 is airborne and the recovery drones can take off and land without a runway then the recovery of the fixed wing UAV 16 can be performed in any location irrespective of ground conditions.
Safety: By having the catching device 12 suspended by two multirotor UAVs 14, the recovery operation can be used away from the operators. Thus, no operators or staff risk coming in contact with the incoming fixed wing UAV 16.
Smaller impact force: By having the two multirotors 14 move against the wind with the fixed wing UAV 16, the relative speed difference between it and the catching device 12 can be made smaller, thus decreasing the structural load on the fixed wing body during impact.
Smaller footprint: By moving the landing operation off ship, operations with UAVs can be conducted from smaller ships, not needing a large open deck with a catching device 12 to support the mission. Land-based operations may only require small vehicles without any specialised adaptations and in some cases recovery via a land-bound operator could be done with manual handling only, i.e. with the multirotors 14 and catching device 12 carried by hand and the recovery system as well as the fixed wing UAV 16 being retrieved by hand as well.

Autonomous recovery of a fixed wing UAV 16 in a suspended catching device 12 is a complex task, so the functionality is split into several key components. The overall mission is executed in the following fashion:
The fixed wing UAV 16 is instructed to follow a path against the wind, with the minimal airspeed required for safe flying. This path can be used to define a virtual runway 20, where the multirotor 14 recovery drones are arranged to fly in such a way as to set a virtual runway 20 that will intercept the flight path of the fixed wing UAV 16.
Both multirotors 14 are equipped with coordinated controllers that keep the inter-formation of the two intact, while lifting the suspended catching device 12.
The current position and the velocity of the fixed wing UAV 16 is transmitted to a coordination controller in one of the multirotors 14, which sends desired setpoints to the formation controllers according to the phases of the mission, in order to catch the fixed wing UAV 16.

FIGS. 1a and 1b show two possible flight paths for the recovery drones 14 to define a virtual runway 20, where the catching device 12 can be used to intercept the fixed wing UAV 16. Precise navigation is crucial for precision landing of UAVs. Navigation for both the recovery drones and the fixed wing UAV 16 can utilize Real-Time Kinematic (RTK) Global Navigation Satellite System (GNSS). This is a navigation technique using the carrier wave of the incoming signals from the satellites, and comparing the signals to that received by a base station. By computing the phase shift between the signals at the fixed wing UAV 16 or the multirotor 14 and the base, the location can be locked in at centimetre-level accuracy. Note that the fixed wing UAV 16 acts as a reference generator (master) in the proposed control scheme, as it is not affected by the current position of the recovery drone multirotors 14. Depending on the type of fixed wing UAV 16 used, it is preferred to keep a steady flight envelope, rather than correcting for minor deviations from the catching device 12 position. This is much better handled by the agility of the multirotors 14. Thus, in effect the virtual runway 20 can adjust to adapt to deviations in the fixed wing UAV 16 flight path, rather than needing to continually adjust the fixed wing UAV 16 flight path for accurate alignment with a traditional runway or with a catching device 12 fixed to the ground or to a ship, as in the prior art.

The fixed wing UAV 16 moves with a constant course and altitude and its position and velocity is communicated to the other vehicles. This is controlled by an on-board autopilot.

In the next sections, let pᵢⁿ ϵ [symbol] , iϵ{1,2} be the position of multirotor 14 i in the inertial frame n. Further, we define the position p̅ⁿ as the centroid of the two multirotors 14 plus a height offset to compensate for the position of the net. Further, the states of the fixed wing UAV 16 is denoted with subscript ⋅f.

The virtual runway 20 defines a path frame {p} at constant altitude, which is defined by an origin pⁿ and a rotation ψ around the {n} z-axis such that Rⁿ=R_{z} (ψ). Then a position pⁿ can be decomposed in {p} by the transformation p^{p}=(Rⁿ)^{T}(pⁿ−pⁿ). By dividing the path frame into a cross-track plane and an along-track distance, we can design controllers for each part separately.

A supervisor of the control system for the recovery drones 14 monitors the position and velocity of the fixed wing UAV 16 relative to the virtual runway 20 in order to switch between the different modes in the manoeuvre. Each mode enables a certain controller and reference which gives a desired velocity setpoint. In addition, the supervisor monitors the manoeuvre as it is progressing. If, because of wind or other factors, the fixed wing UAV 16 misses the catching device 12 then it instructs the vehicles to try the manoeuvre again. Further, if the projected proximity of the fixed wing UAV 16 and multirotors 14 are too small, the supervisor can abort the operation. Depending on the situation, an abort can involve the multirotors 14 climbing and repositioning for a retry, or releasing the net and abort the mission entirely.

For control purposes, the virtual runway 20 is divided into a cross-track plane and an along-track distance. The position of the catching device 12 is controlled according to the fixed wing UAV 16 position in the cross-track plane along the virtual runway 20. A cross-track frame {p*} is defined as the yz-plane in the path frame {p}, such that the position in the crosstrack plane can be extracted from the position in the path frame.

To control the velocity setpoint in the crosstrack plane for the multirotors, a modified pure-pursuit scheme is introduced. Given a desired position p_{d} and the position error p̅*:=p_{d}−p* the following controller is used

v^{p*}=K_{p,p}\tilde{p}^{p*}+K_{d,p}\tilde{p}^{p*}+K_{i,p}\dot{\tilde{p}}^{p*}

where K_{j,p}ϵR^{2×2} for jϵ{p, i, d}. The desired position p_{d}=p_{f,2:3} is defined as the current position of the fixed wing UAV 16 projected along the virtual runway to the cross-track plane.

It should be noted that the position of the catching device 12 is not measured explicitly, and furthermore it is not a desirable control target as the catching device 12 may swing during the transit. Therefore we seek to control a position p⁻ defined in the cross-track plane. Hence, p^{p}*=\tilde{p}2:3.

The relative velocity between the net and the fixed-wing UAV is reduced by accelerating the net to a desired velocity. In order to control the point of impact an, open loop scheme is proposed.

For the final recovery phase, the along-track velocity of the fixed-wing UAV 16 is assumed constant. The virtual runway 20 defines a point r_{c} along the runway as the designated recovery point. While waiting at the start of the virtual runway 20, the multirotor UAVs 14 should monitor the location of the fixed-wing UAV 16. Based on a operator-defined relative speed to be achieved by the multirotors 14 at the point of recovery r_{c}, the multirotor UAVs 14 will start a pre-defined velocity profile along the virtual runway, to intercept the incoming fixed-wing UAV 16 at r_{c}. By knowing the type of velocity profile used, the distance to the fixed-wing UAV 16, r₀, can be calculated based on the desired relative speed and along-track velocity of the fixed-wing UAV 16.

A dynamical model of a multirotor 14 can be derived by Newtonian or Lagrangian methods as is known in this field. By further assuming the presence of an internal attitude controller, the relevant dynamics for the control design is extracted.

Let the dynamics of multirotor i be modelled by

\dot{p}ᵢ=vᵢ

mᵢ\dot{v}ᵢ=mᵢg+Rᵢfᵢ

\dot{R}ᵢ=RᵢS(ωᵢ)

Iᵢ\dot{ω}ᵢ=S(Iwᵢ)ωᵢ+Mᵢ

where pᵢϵ [symbol] is the UAV position in the inertial frame {n}, vᵢϵ [symbol] the translational velocity in n, Rᵢ a rotation matrix from the body-fixed frame bᵢ to the inertial frame n, ωϵ [symbol] the angular velocity of the UAV, represented in bᵢ. Further, the operator S( ) is the skew-symmetric transformation, such that p q=S(p)q. mᵢ is the mass of the multirotor 14, and Iᵢ the body-fixed inertia matrix. fᵢ is upwards thrust directed along the negative body-aligned z-axis, Mᵢ are applied moment about the multirotor 14 centre of gravity, and g=[0 0 g]^{T} where g is the gravitational constant. Consider now the net being suspended in the centre of gravity of the UAV. This will affect the translational motion by a forceτ_{L,i}, given by the load dynamics, but the rotational motion is unaffected. As control of the attitude of the multirotor 14 is not considered, the model considering the translational motion is now

mᵢ\dot{v}ᵢ=mᵢg+Rᵢfᵢ+τ_{L,i}

Further, assume now that a sufficiently fast attitude controller is present. The direction of the applied force for translational motion (5) is given by Rᵢ, and by manipulating the roll and pitch of the UAV we can apply force in a desired direction. Thus, the term Rᵢfᵢ can be replaced by an inertial control force Fᵢϵ [symbol] , resulting in the linear dynamics

mᵢ\dot{v}ᵢ=mᵢg+Fᵢ+τ_{L,i}

The formation controller can be designed in two steps using a passivity-based approach, where an inner loop controller takes a velocity setpoint from an outer controller, and the stability of the cascaded structure is proved by passivity theory. While the inner controller uses only its own measurements, the outer uses available information from the other multirotor 14 to reach the desired formation.

First, let

Fᵢ=τ_{L,i}+mᵢg−Kᵢ(vᵢ−v_{d})+mᵢ\dot{v}_{d}+uᵢ

where v_{d} is the desired common velocity from the coordination controller, known to both vehicles. uᵢ R³ is the input from the outer loop formation controller, which acts as an injection to achieve a desired formation, to be specified later. Note that we assume we can measure the disturbance force τ_{L,i} of the suspended catching device 12, so it can be compensated using feed-forward by the controller.

Next, let z=p₁−p₂ be the vector between the two multirotors 14 in {n}.

A standard linear consensus protocol can now be applied as

uᵢ=dᵢKᵢ(z−z_{d})

where d₁=1, d₂=−1, where z_{d} is the desired link vector.

To provide a thorough understanding of the dynamical motion of the of the combined multirotor 14-catching device 12 system during the recovery manoeuvre a simulator can be used that includes the full 6-DOF dynamics of the multirotors 14, fixed wing UAV 16, and the catching device 12 suspended under the multirotors 14. This can be used to model the impact forces during collision, with consequential adaptations being made in the control of the multirotors 14.

By having the catching device 12 attached to the multirotors 14, we have in effect a system of constrained motion where each wire connecting the catching device 12 removes one degree of freedom. For simplicity, the catching device 12 is considered as a rigid body. To model this behaviour, one can reduce the state-space and use only generalized coordinates that cover the configuration space. This, however, will hide the forces acting on the wires during impact. Instead, one chose to model the interconnected system with constrained coordinates. The Udwadia-Kalaba equation, can be used to explicitly calculate the forces of constraints acting on each body.

To consider the dynamics during the impact, when the fixed wing UAV 16 gets arrested by the suspended catching device 12, the collision can be assumed to be perfectly inelastic such that the bodies will stick together after the collision. In order to calculate the forces and moments on the suspended catching device 12, conservation of momentum can be applied.

A numerical simulation was carried out using the controllers and models presented in the previous sections. We consider two multirotors 14, with a mass of m1,2=6 kg, recovering an incoming fixed wing UAV 16 at mf=3 kg. The fixed wing UAV 16 is approaching at a constant speed of 15 m/s, and the multirotors 14 are set to reach an approach-speed of 7 m/s. Further, the multirotors 14 are equipped with a basic autopilot that handles attitude setpoints, as discussed above, which is implemented as a PD control structure. Next, we consider the catching device 12 as a net with a width and height of 5 and 3 m, respectively. FIG. 3 shows a recovery system using a net as the catching device 12. The numerical simulation is conducted in MATLAB, using Runge Kutta 4 as integrator at 50 Hz. The total thrust of each multirotor 14 is configured such that it uses half of the available power at hover. Due to the construction of the multirotor 14, the available torque is likewise limited so that each motor does not exceed its maximum. The multirotor 14 has a motor-to-motor diameter of 1 m. Further, discrete time sampling is implemented with a zero-order-hold. The net is attached 10 cm below the Centre of Gravity of each multirotor 14.

In the simulation the multirotors 14 successfully intercept the incoming fixed wing UAV 16 and are able to handle the load during impact. The tension force on each of the multirotors 14 oscillates around a steady value in the z axis that is equivalent to half of the weight of combined net and fixed wing UAV 16. Due to a slight twist in the net when it swings, a slight transient can be seen on the y-component of the tension force. After impact, some residual oscillations remain due to the swinging payload.

An example operation procedure for recovery of a fixed wing UAV 16 with multirotor recovery drones 14 is described below.

The fixed wing UAV 16 takes off based on its standard operation procedure. For ship-based operations, this will typically include a catapult or similar. Before takeoff, the recovery pod bay, consisting of a releasable wire with a hook 18 and communication system is mounted under the fixed wing UAV 16 at a hard point.

To initiate the recovery, two or more multirotors 14 are prepared. As they are able to take off and land vertically, minimal space allocation is required. For the sake of this example, consider two multirotors 14.

The two multirotors 14 are set up 5 m from each other on the ship deck. The catching device 12 is attached to the bottom of the multirotors 14, and connected between the two multirotors 14.

Before launch of the multirotors 14, the location of the virtual runway is specified. This is either specified by an operator, based on surroundings, local regulations, weather, or done automatically. The operator can in the latter case adjust and accept the suggested virtual runway. The virtual runway can be oriented such that the recovery is performed against the wind, thus minimizing ground speed.

Parameters for the recovery operation, such as rendezvous speed, fixed wing cruise speed, and safety-constraints are set based on the physical parameters of the multirotors 14 and fixed wing UAV 16.

The location and orientation of the virtual runway is transmitted to the fixed wing UAV 16, which is instructed to follow this runway with the prescribed speed. Alternatively the virtual runway can be defined based on a previously set flight path of the fixed wing UAV 16.

To minimize the battery-drain on the multirotors 14, the time of which the multirotors 14 takes off from the ship is calculated based on location of the virtual runway from the ship, total flight time, and location of the incoming fixed wing UAV 16. Based on the speed of the fixed wing UAV 16, the multirotor take-off is initiated so they reach the start of the virtual runway in time to start the recovery manoeuvre.

Navigation solution of the multirotors 14 is checked, based on high precision satellite system or other local radio-based localization systems.

The multirotors 14 are set in a special control mode, coordinated mode, in which they act as a single unit. Take-off is initiated either automatically, or operated by a single pilot. In the automatic mode, the two multirotors 14 simultaneously and coordinatedly fly straight up and away from the ship deck. In the operator assisted mode, the operator uses a single control stick to fly both multirotors 14. Special control algorithms make sure the position between the multirotors 14 stays the same.

When the multirotors 14 have reached cruising altitude (either automatic or pilot assisted), the multirotors 14 go to a formation (relative position) optimal for cruise travel towards the start of the virtual runway. The optimal cruise relative position may depend on the recovery mechanism used (net or rope), the number of multirotors 14, wind direction, etc. They then move to the start of the virtual runway, and align themselves with the recovery mechanism (net or line) perpendicular to the virtual runway.

Position and velocity data from the fixed wing UAV 16 is transmitted to the multirotors 14 from the communications device in the pod. Based on this information, the multirotors 14 automatically starts to move along the virtual runway with a prescribed velocity as to recover the fixed wing UAV 16 at a designated location. Alternatively they may take a fixed position for interception of the fixed wing UAV 16 with zero groundspeed for the multirotors 14.

A graphical user interface (GUI) on the Command Control Centre (CCC) computer on the ship deck lets the operator continuously monitor the progress of the recovery manoeuvre, including vital parameters such as battery capacity, wind conditions, communication link status, etc. At any point, the operator can issue commands to the system to stop, retry or abort the recovery.

The system automatically detects a successful recovery based on on-board sensors. In the case of a miss or aborted recovery (due to communication loss, localization misalignment or changing weather conditions), the system can issue a retry. The fixed wing UAV 16 is instructed to fly around, and the multirotors 14 move towards the start of the runway again for a second attempt.

For a successful recovery, the multirotors 14 automatically moves back to the ship, with the fixed wing UAV 16 still attached to the catching device 12. When close to the ship, case must be taken to safely land and touch down the fixed wing UAV 16 on the ship deck. For automatic operations, the multirotor UAVs measure the position of the ship deck from satellite or other local measurement systems (camera, radio), and position themselves directly over the ship deck. They lower the fixed wing UAV 16 until touch-down is confirmed either by tensile sensors on the attachment device on each multirotor or other mechanism. When the fixed wing UAV 16 is safely on the ground then the multirotors 14 release the catching device 12 and drop it over the fixed wing. For pilot assisted touch-down, special control software lets a single pilot operate the location, altitude and orientation of the multirotors 14 with the suspended fixed wing UAV 16. The pilot guides multirotors 14 towards a safe landing area on the ship deck, and lowers the multirotors 14 until the fixed wing UAV 16 successfully touches down on the ship deck. Various measurement systems, such as radio, satellite or camera can assist the pilot to compensate for inherent motion of the ship deck do to waves and wind.

When the multirotors 14 have detached the suspended fixed wing UAV 16, either through pilot assisted or automatic operations, the multirotors 14 are landing on the ship deck one by one. Based on the number of multirotors 14, a queuing system might be used. The multirotors 14 either land automatically, based on positioning data from satellites or local measurements systems as described above, or manually from a single pilot one by one.

The complete system is built to be modularized, such that the recovery mechanism, multirotors 14 and housing for the hook system 18 can be interchanged to match each recovery mission criteria.

1. An unmanned airborne vehicle (UAV) recovery system for in-flight recovery of a fixed wing UAV, the recovery system comprising:
a catching device comprising a line for catching the fixed wing UAV during flight of the fixed wing UAV via a hook system; and
a plurality of hover-capable recovery drones;
wherein the recovery drones are arranged to support the line as it spans a gap in a horizontal orientation with the line suspended between at least two recovery drones that are in flight and spaced apart horizontally from each other either side of the gap; and
wherein the recovery drones are arranged to co-ordinate their movement to adopt a flight path relative to a flight path of the fixed wing UAV to define a virtual runway for interception of the fixed wing UAV by the recovery system.

2. A UAV recovery system as claimed in claim 1, wherein the line of the catching device is a flexible line arranged to hang suspended between the at least two recovery drones.

3. A UAV recovery system as claimed in claim 1, wherein the line has a length of 5-100 m and is suspended across a gap of 10-40 m.

4. A UAV recovery system as claimed in claim 1, including the hook system for attachment to the fixed wing UAV, wherein the hook system includes a hook and a hook line holding the hook.

5. A UAV recovery system as claimed in claim 4, wherein the hook system is provided with a housing for holding the hook line in a stowed arrangement during normal flight.

6. A UAV recovery system as claimed in claim 4, wherein the hook system is arranged to deploy the hook when the fixed wing UAV is within a certain distance of the recovery drones and/or when the fixed wing UAV is within a certain flight time from interception with the catching device at the virtual runway.

7. A UAV recovery system as claimed in claim 4, wherein the hook and line are deployed using gravity with the weight of the hook pulling the hook line from its stowed arrangement to a deployed arrangement where the hook and the hook line hang beneath the fixed wing UAV.

8. A UAV recovery system as claimed in claim 4, wherein the hook or the hook line is provided with aerodynamic features for using the airspeed of the UAV to generate a downward force to aid deployment of the hook.

9. A UAV recovery system as claimed in claim 4, wherein the recovery system or the hook system is arranged to provide a signal to the fixed wing UAV to trigger a shut down of the fixed wing UAV's propulsion system when the hook engages with the catching device or when the UAV or the hook is within a certain distance of the catching device.

10. A UAV recovery system as claimed in claim 1, wherein the recovery drones are arranged to co-ordinate their movement to fly in the same direction as the fixed wing UAV so that the relative velocity of the recovery system and the fixed wing UAV is reduced.

11. A UAV recovery system as claimed in claim 1, wherein the recovery drones provide a virtual runway that travels in the same direction as the fixed wing UAV at a lower speed than the fixed wing UAV.

12. A UAV recovery system as claimed in claim 1, wherein the recovery system is arranged to use control of the recovery drones to damp and/or absorb impact forces and the recovery drones are arranged to react to impact of the fixed wing UAV at the catching device by applying lift to counteract the impact forces by control of each recovery drone such that in reaction to motion and/or forces arising due to impact of the fixed wing UAV then the recovery drones apply additional lift to maintain, restore or modify the flight path of the recovery drones.

13. A UAV recovery system as claimed in claim 1, wherein the recovery system is arranged to use control of the recovery drones to damp and/or absorb impact forces and the recovery drones are arranged to detect motion or forces induced by impact of the fixed wing UAV via sensors on the recovery drone, and to use input from the sensors as well as control inputs from feedback systems on the recovery drone, such as gyroscopic systems, to react to impact of the fixed wing UAV at the catching device by applying lift to counteract the impact forces in order to maintain stable flight of the recovery drones as well as to maintain, restore or modify the flight path.

14. A UAV recovery system as claimed in claim 1, wherein the recovery system is arranged to use control of the recovery drones to damp and/or absorb impact forces, the recovery system includes one or more sensors for sensing the magnitude and/or direction of tension forces applied to the drone by the catching device to allow for detection of the impact forces, and the recovery drones are arranged to react to impact of the fixed wing UAV at the catching device by applying lift to counteract the impact forces in order to maintain stable flight of the recovery drones as well as to maintain, restore or modify the flight path taking account of the direction and/or magnitude of the tension applied to the recovery drone by the catching device.

15. A UAV recovery system as claimed in claim 12, wherein the recovery drone flight path is modified in order to absorb impact forces by permitting the recovery drones to move into the horizontal gap that was spanned by the catching device prior to impact of the fixed wing UAV.

16. A UAV recovery system as claimed in claim 12, wherein the recovery drone flight path is modified in order to absorb impact forces by acceleration or deceleration of the flight speed along the flight path of the virtual runway.

17. A UAV recovery system as claimed in claim 1, wherein the recovery system includes shock absorbing features at the catching device comprising: a shock absorbing line, such as a line that extends under load and absorbs or dissipates forces during extension; and/or shock absorbers attached to the catching device within the load path and using damping or plastic deformation to absorb or dissipate forces.

18. A method for recovery of a fixed wing unmanned airborne vehicle (UAV) during flight, the method comprising:
using a plurality of hover-capable recovery drones, supporting a catching device as it spans a gap in a horizontal orientation with the catching device suspended between at least two recovery drones that are in flight and spaced apart horizontally from each other either side of the gap, wherein the catching device is a line for catching the fixed wing UAV during flight of the fixed wing UAV using a hook system attached to the UAV;
co-ordinating movement of the recovery drones in order to that they adopt a flight path relative to a flight path of the fixed wing UAV; and
thereby defining a virtual runway for interception of the fixed wing UAV by the recovery system.

19. A method as claimed in claim 18, comprising using a recovery system as claimed in claim 1.

20. A method as claimed in claim 18, wherein the hook system includes a hook with a hook line attached, wherein the hook line has a length allowing for the fixed wing UAV to fly above the recovery drones whilst the hook hangs below the level of the line supported between the drones and the method includes catching the fixed wing UAV by hooking the hook onto the catching device line so that the fixed wing UAV is then attached to the catching device, and hence to the recovery drones, by the hook line.

21. A method as claimed in claim 20, comprising using the hook system to deploy the hook when the fixed wing UAV or the hook is within a certain distance of the recovery drones and/or is within a certain flight time from interception with the catching device at the virtual runway.

22. A method as claimed in claim 18, wherein each of the recovery drones is flown in co-ordination both with the other recovery drone(s) and with the flight path of the fixed wing UAV to be recovered and the method includes controlling the fixed wing UAV in a way that is blind to the presence of the recovery system, with the recovery system matching its movements with the fixed wing UAV flight path.

23. A method as claimed in claim 18, wherein the movement of the recovery drones is in the same direction as the fixed wing UAV so that the relative velocity of the recovery system and the fixed wing UAV is reduced.

24. A method as claimed in claim 18, wherein flight path of the UAV and hence the flight path of the virtual runway is aligned with weather conditions so that the fixed wing UAV is flying into the wind when it lands.

25. A method as claimed in claim 18, comprising absorbing impact forces from the catching of the fixed wing UAV via shock absorbing features of the catching device and/or via control of the recovery drones to damp and/or absorb forces from the impact.

26. A method as claimed in claim 25, comprising using control of the recovery drones to damp and/or absorb forces from the impact by controlling the recovery drones to react to impact of the fixed wing UAV at the catching device by applying lift to counteract the impact forces such that in reaction to motion and/or forces arising due to impact of the fixed wing UAV then the recovery drone applies additional lift to maintain, restore or modify the flight path of the recovery drone.

27. A method as claimed in claim 26 including detecting motion or forces induced by impact of the fixed wing UAV by using sensors on the recovery drone, and then using input from the sensors as well as control inputs from feedback systems on the recovery drone, such as gyroscopic systems, in order to maintain stable flight of the recovery drone as well as to maintain, restore or modify the flight path.

28. A method as claimed in claim 26, wherein the system includes one or more sensors for sensing the magnitude and/or direction of tension forces applied to the drone by the catching device and the method includes detecting a change in magnitude and/or direction in order to detect the impact forces, and then controlling the recovery drone to react to impact of the fixed wing UAV at the catching device by applying lift to counteract the impact forces taking account of the direction and/or magnitude of the tension applied to the recovery drone by the catching device.

29. A method as claimed in claim 26, wherein the recovery drone flight path is modified in order to absorb impact forces by permitting the recovery drone to move into the horizontal gap that was spanned by the catching device prior to impact of the fixed wing UAV and/or by accelerating or decelerating the co-ordinated movement of the recovery drones along the flight path of the virtual runway.

30. A method as claimed in claim 18, comprising catching the fixed wing UAV, absorbing impact forces from impact of the fixed wing UAV, and then carrying the fixed wing UAV as a suspended load.

31. An unmanned airborne vehicle (UAV) recovery system for in-flight recovery of a fixed wing UAV, the recovery system comprising:
a catching device for catching the fixed wing UAV during flight of the fixed wing UAV; and
a plurality of hover-capable recovery drones;
wherein the recovery drones are arranged to support the catching device as it spans a gap in a horizontal orientation with the catching device suspended between at least two recovery drones that are in flight and spaced apart horizontally from each other either side of the gap; and
wherein the recovery drones are arranged to co-ordinate their movement to adopt a flight path relative to a flight path of the fixed wing UAV to define a virtual runway for interception of the fixed wing UAV by the recovery system.

32. A UAV recovery system as claimed in claim 31, wherein the catching device is a line supported across a horizontal span by drones at either end of the line, or a net that is hung from the recovery drones and/or suspended between the recovery drones.

33. A UAV recovery system as claimed in claim 31, wherein the catching device is a flexible line arranged to hang suspended between the recovery drones.

34. A method for recovery of a fixed wing unmanned airborne vehicle (UAV) during flight, the method comprising:
using a plurality of hover-capable recovery drones, supporting a catching device as it spans a gap in a horizontal orientation with the catching device suspended between at least two recovery drones that are in flight and spaced apart horizontally from each other either side of the gap, wherein the catching device is for catching the fixed wing UAV during flight of the fixed wing UAV;
co-ordinating movement of the recovery drones in order to that they adopt a flight path relative to a flight path of the fixed wing UAV; and
thereby defining a virtual runway for interception of the fixed wing UAV by the recovery system.

35. A method as claimed in claim 34, comprising use of a UAV recovery system as defined in claim 1 and/or comprising method steps as defined in claim 18.

36. A computer programme product comprising instructions that, when executed on a control network for controlling hover-capable recovery drones, will configure them to operate in accordance with the method of claim 18, including supporting a catching device and co-ordinating the drones' flight to define a virtual runway.
